(19) United States
(12) Patent Application Publication
(10) Pub. No.: US 2010/0233420 A1
(43) Pub. Date: Sep. 16, 2010

(54) COMPOSITE STEEL CLADED MILL LINER

(75) Inventors: Somenath Ghosh, West Bengal (IN); Koushik Sengupta, West Bengal (IN)

Correspondence Address: VENABLE LLP, P.O. BOX 34385, WASHINGTON, DC, 20043-9998, US

(73) Assignee: Tega Industries Limited, Kolkata (IN)

(21) Appl. No.: 12/738,219

(22) PCT Filed: Mar. 27, 2008
(86) PCT No.: PCT/IN08/00194

§ 371 Date: Apr. 15, 2010

(30) Foreign Application Priority Data
Oct. 18, 2007 (IN) 1428/KOL/2007

(51) Int. Cl. B32B 3/06; B32B 15/06; B22D 23/00

(52) U.S. Cl. 428/99; 428/457; 428/332; 164/76.1

(57) ABSTRACT

The invention discloses a composite liner for ball mills comprising an upper layer of alloy cast steel bonded on a symmetrically distributed lower rubber surface, said cast steel layer is prefabricated so as to form the desired profile on the upper surface of the said liner required for specific grinding operations. The present invention also discloses a method of manufacturing composite mill liner.

This invention relates to an effective tool for grinding of ore minerals, rocks and other materials. Particularly, this invention relates to a liner to be used in the mill for grinding in course of mineral processing operations. More particularly, this invention relates to a composite steel claded mill liner for use in AG and SAG mills.

### BACKGROUND OF THE INVENTION

Grinding mills are typical equipments for mineral processing as mentionea above. A standard grinding mill generally has a drum shaped shell connected to conical/vertical mill heads with integral or bolted trunnions and the assembly is mounted on the journal pad bearings for it's rotation. Semi-Autogenous Grinding Mill or SAG is a typical mill which unlike ball mills uses steel balls along with rock feed material as media to break the rocks in grinding operations. The rotating drum continuously throws the rocks and the balls in a cataracting motion causing breakage of the bigger rocks primarily by impact. Attrition in the charge causes grinding of finer particles. SAG mills has, in its inner surface, lifter bar & shell plates as liners to carry the ball charge & ore/rocks inside up to a point known as the charge should or where the centrifugal forces acting on the charge components get equal to the wt of the charge components. This effects in the parabolic charge fall off towards the toe region under the influence of tangential velocity & the acceleration due to growth. This movement on the charge facilitates the objective grinding.

In contrast, Autogenous mills or AG mills do not use steel balls. The rotating drum throws only the ore/rock which causes impact breakage of the ore. Attrition in the rock media charge also causes grinding of finer particles either present in the feed or gets generated in course of rock breakage in course of milling.

The significant impact forces generated during the operation of the grinding mills, due to continuous collision between the steel balls, ore and the inner shell liners of the rotating drum while comminuting the ore to finer particles also causing degradation of the grinding media and the liner of the drum. In view of the wear life cycle of the lining system being used, operation downtime for the machine along with a vital segment of the OPEX is manifested at the user's end. More the wear life cycle of the liners, better is the availability of the machine, which is desired.

In order to minimise the rate of wear and to prolong the life of the liners, various types of liners have been used. Normally, complete cast alloy steel liners, low metal & high rubber blended polymet lining system and only rubber liners are used in the AG/SAG Mills. Magnetic liner materials are also known to be used to retain in place the chips or flakes of the liners generated due to severe impact & abrasion on them in course of the grinding process. However, the above various liner materials have their individual limitations and do not provide very satisfactory results so far as the desired life of liner is concerned against aggressive operating conditions.

Further, replacement of inner lining of the mill is a cumbersome procedure and the types of liners mentioned above are operation specific and cannot be retrofitted, in the grinding mills. Also, the constructional design of the liners used in the state of the art is dependent on the drilling patterns in the mill. Polymet or rubber liners are in the form of bar or plates. Bar is responsible for the charge lift. The plate is located in between the bars and each bar has to be individually bolted to the shell. In such a system, therefore, the number of bars or lifts is totally dependent on the number of holes present in a row available in the shell of the mill. In case of only cast liners, profile takes care of both lifter & plate in a single price resulting in heavy weights of the individual liners. As the cast liners are heavy & the deflection during the impact is very low, size of the fixing hardwares are also bigger & more time consuming for fixing & dismantling. Except for the cast steel liners, no other forms of liners available in the industry at present are capable of initiating effective grinding in course of the bi-directional shell rotation.

So, there has been a constant need of an improved liner for the inner shell of grinding mills which can overcome the above mentioned shortcomings.

### OBJECT OF THE INVENTION

Therefore, it is an object of the present of invention to provide a liner, which would provide greater wear life cycle for the grinding mills.

It is another object of the invention to provide a liner for the grinding mills, which can be easily retrofitted in a mill having some different shell hole drilling layout not conducive for the specific application.

It is yet another object of the invention to provide a liner for grinding mills which is relatively light weight compared to the cast steel liners, thereby reducing the inertia effect of the mill drive system and delivering comfort to the motor in terms of starting time.

It is a further object of the invention to provide a liner for the shell of the grinding mills which is independent of the drilling pattern of the existing shell in terms of fixing.

It is a further object of the invention to provide a liner for the mills suitable for the bi-directional share rotation. It is a further object of the invention to provide a relatively lesser fastener sizes compared to the cast steel liners so that the additional facility requirement & down time for the installation/dismantling can be minimized.

It is another object of the invention to provide a liner for the grinding mill based on this concept which can be manufactured in a tailor made fashion for different milling application.

These and other objects of the invention will be apparent from the description of the exemplary embodiments of the invention described hereinafter. Of course, the present invention is not limited to such embodiments or to the drawings with the help of which the embodiments are described, purely for explaining the invention, by way of example.

### SUMMARY OF THE INVENTION

To achieve the above and other objectives, the invention provides a composite liner for ball mills comprising an upper layer of alloy cast steel bonded & anchored in a symmetrically distributed lower resilient rubber surface. Engineered steel segment is pre-cast so as to form the desired profile on the upper surface of the said liner required for specific grinding operations.

Preferably the upper steel layer is made of chrome-moly type alloy cast steel. The upper steel layer and lower rubber layer are further fastened by integral metal anchor.

Said anchor is embedded within the rubber layer.

Thickness of said upper metal layer is greater than the said lower rubber layer.

Preferably the metal layer thickness in the plate area is at least around 40 mm excluding the anchor section.

Preferably the said rubber layer has a thickness of at least around 20 mm.

The said liner is capable of being retrofitted in a SAG/AG mill independent of the number of holes present in a row available in the shell of the mill.

As the metal layer wears out, the liner becomes more resilient and its relative wear rate decreases.

The invention also provides a method of manufacturing composite mill liner comprising the steps of pre-casting metal part according to the required liner profile, heat treatment and sand blasting the cast metal profile for surface cleaning, applying rubber adhesive compound to the intended bond area of the metal part, making the transfer mould assembly with the top cavity of the mould holding the metal profile and lower cavity of the mould holding the aluminium clamp inserts. Hot rubber blank is symmetrically placed in the lower mould cavity. Both the cavities are placed on the hot press platen & are kept closed under designated pressure & temperature for a specific curing time to ensure that the metal-rubber bond is complete & cured to be put for the intended service.

Preferably the hydraulic press is of 1000 T capacity and heating process is carried out at 172 deg C. platen temperature.

### BRIEF DESCRIPTION OF THE ACCOMPANYING DRAWINGS

FIG. 1 is a cross-sectional view of an exemplary grinding mill fitted with the inventive liner.

FIG. 2 is a graph showing the relative wear of the mill liner over time.

FIG. 3 Illustrates a preferred embodiment of the mill liner according to the invention.

FIG. 4 Illustrates another preferred embodiment of the mill liner according to the, invention.

### DETAILED DESCRIPTION OF THE INVENTION:

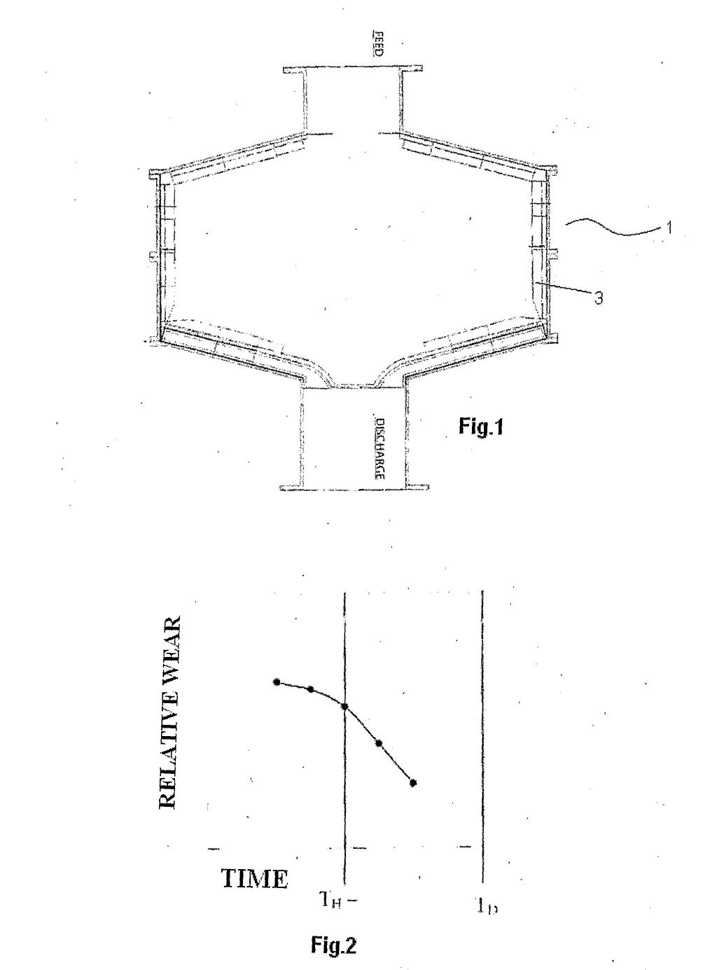

According to the invention, a symmetrically distributed soft rubber backing on a composite liner system, as shown in FIG. 1 is disclosed. The inside wall of the shell of the grinding mill, (1) is retrofitted with a rubber backed composite mill liner (3). The liner has a top layer made of cast steel. An example of the inventive liner is chrome-moly cast steel layer with integrated rubber back layer. Natural rubber can be used to make the rubber layer. These two layers make an integrated system of rubber backing and composite lining. The two layers are joined together by hot vulcanization in course of transfer moulding.

The inventive liner has done away with the present concept of fixing lifter bars on the shell. Instead the instant liner is an integrated single profile of bar or bars and plate or plates. Therefore, independent of any number of holes available in a row but depending only on the number of lifts required for a specific application individual profile can be designed. Therefore any sort of retrofitting is possible in this liner. The integrated liner is fitted on the shell in the known manner associated with the light weight rubber or polymet liners such as by using clamp or bolt or nut or seal.

Due to presence of symmetrically distributed and soft rubber backing in the liner, the wear rate of the steel surface is less compared to that in the Polymet lining system or in the composite metal liner. Due to this unique distribution of metal-rubber system in the liner as the metal wears down, liner becomes more resilient and its relative wear rate decreases. The effect becomes much more significant after the liner has attained its half life period. This effect is shown in FIG. 2. The slope of the curve clearly indicates that the relative wear rate sharply decreases after the half life T_{H} line. The T_{D} line shows the time for discarding the liner.

On the liner, further arrangement if necessary for the grinding operation, such as lifter profile of required shape can be arranged, by casting the metal part with the designated profile.

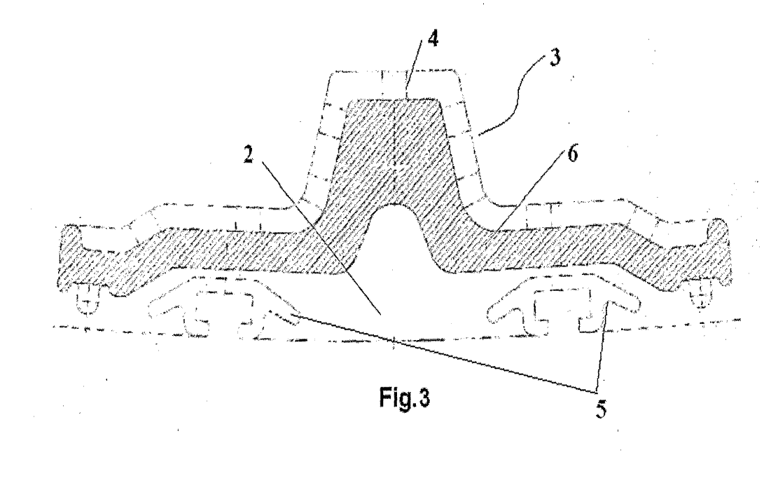

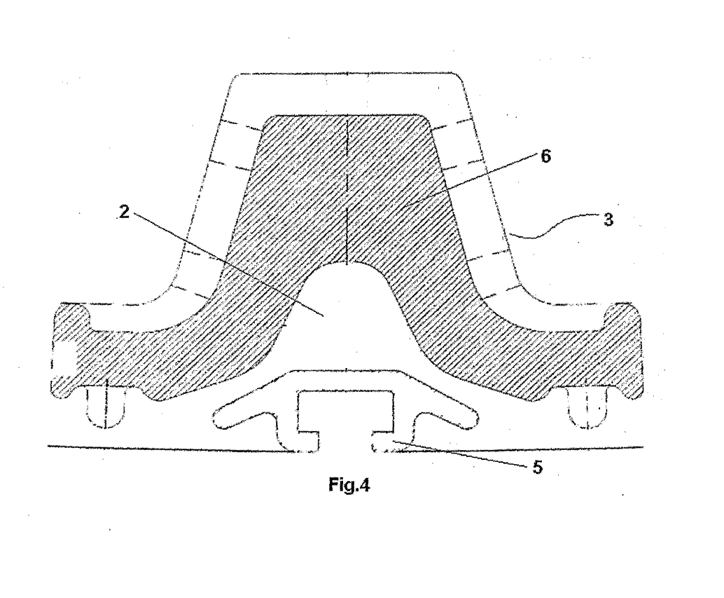

FIG. 3 shows the cross sectional view of the composite liner system with one lifter (4) and having two point fastening system (5) with the shell. Hatched section (6) represents solid steel casting. On top of the casting, a bidirectional cast metal grid system is shown. Grid section has been provided as a retardant to the in process wear. Integral anchors of the metal section have been shown at the two ends embedded in rubber to ensure adequate protection against rubber metal separation due to the force encountered by the liner while negotiating its movement across the toe zone with higher dynamic pressure in the mill. Two aluminum clamps are also shown at the point of fixing. All remaining un-shaded zone (2) represents rubber.

FIG. 4 shows a cross section of a composite liner profile with one lifter and with a single point fastening system. Hatched section (6) represents solid steel casting having bi directional grid system on top, integrated anchor system and aluminum clamp are also shown. Un-shaded area (2) represents rubber.

The thickness of the steel cross sectional area is kept more than that of the rubber in this liner system. In fact, this is one of the basic difference of this inventive liner with that of the polymet liners.

Layer thickness of steel will not be uniform all over and will depend on the specific application. The rubber thickness for this liner is not meant to provide only wear and corrosion resistant support. Basic function of the rubber layer here is to provide resilient support which will counter the forces exerted by the dynamic charge on the lifter and plate inside the mill. As an example minimum metal layer thickness in the plate area should be around 40 mm excluding the anchor section. The corresponding clear rubber thickness can be in the range of 20 mm-50 mm. As a corollary, if the thickness of the metal, in worn out condition, in the plate area along with the height of the lifter becomes 5 mm, the total thickness of the liner becomes around 50 mm.

The inventive liner is manufactured in a stepwise process. The metal part is duly cast according to the required lifter profile and heat treated and the cast metal profile is sand blast for surface cleaning. Rubber adhesive compound is applied to the bonded area of the metal part and aluminium clamp inserts. Thereafter the transfer mould assembly is made ready with the top part of the mould holding the metal profile and lower part of the mould holding the aluminium clamp inserts. Now hot rubber blank is distributed symmetrically in the lower mould part in the hydraulic press of 1000 T capacity and the platen holding the mould cavities are heated at 172 deg C. temperature. The prefabricated mould is closed in the press and pressed to fix it to the lower rubber layer. The pressing time varies from 2 to 3 hours for proper vulcanization and bonding of the metal profile on the rubber layer thereby making it an integrated metal-rubber liner profile. After the bonding and vulcanization are completed, the liner is removed from the mould.

In this line, thus it is possible in this liner to arrange for different number of lifter in a given area according to the need without being dependent on the number of rows available. The liner of the invention can be produced in a tailor made arc lengths and fixing arrangements to make retro-fitment in any mill much easier and faster.

It will be apparent to a person skilled in the art that due to the above characteristics of the liner the drilling pattern of the mill shell is not significant. Number of lifts or number of rows of lifter in the shell can be altered without changing the shell. This flexibility will help the user to convert any used ball mill to SAG or FAG mode. This liner can also be used where pure rubber or polymet liner can not be used as an alternative to the metal liners such as for lining in SAG/FAG mills of diameter of more than 9 meters.

Due to less weight in comparison to equivalent steel liner, GD² value of the mill will also decrease significantly.

Specific Gravity of cast steel would be in the range of 7.6 to 7.85 kg/dm³ Whereas Specific Gravity of rubber used in the composite liner would be 1.14 to 1.16 kg/dm³. As the cross section of the composite liner has some cast steel & some rubber, for a given shape of the liner of occupying volume V, weight of the steel liners would be (7.6−7.85)×V kg. Whereas, the weight of the composite liners would be {x*(1.14−1.16)+(V−x)*(7.6−7.85)} kg.[ x: volume of rubber.] From the above expressions, it is clear that the weight of steel liners would be more than that of the inventive composite liner for any given shape and volume.

GD² value of a rotary equipment is its inertia effect automatically narrated as: 4*WK² (W: weight of the rotating mass and K: radius of Gyration).

As the liner weight with the composite lining system would be less compared to that of the complete metal lining system, rotary mass of the grinding mill with the liners would be less with the composite lining system.

Starting time of the drive motor is =K.GD²/Ta (when Ta=average acceleration torque and K=const).

As the GD² value referred to the motor becomes less, starting becomes easy and the time required to effect the same is also lesser. Thus, thermal withstand time for each start would be less for the driver motor giving it the relief which is manifested in terms of working life of the motor.

Tumbling movement of charge induces large impact on the lining system in a cyclic pattern. This in turn causes lot of chipping wear along with abnormal stresses in the fixing fasteners. With the inventive resilient composite system, the magnitude of impact reduces by 5 to 6 times of its real intensity, hence the chances of damage becomes less. Therefore the efficacy of the inventive liner will be far superior to all other types of liner for the conditions where applications calls for partial cataraction of change in the mill to deal with the materials having high front end competency. Thus difficult FAG/SAG operation can be addressed with this type of liners.

It is to be understood that the inventive concept has been described with the help of non-limiting exemplary embodiments. The scope of the invention is to be construed, as defined in the appended claims. Various alterations, modifications and improvements may be made without departing from the scope and spirit of the invention.

1. A composite liner for ball mills comprising an upper layer of alloy cast steel bonded on a symmetrically distributed lower rubber surface, said steel layer is pre-cast so as to form the desired profile on the upper surface of the said liner required for specific grinding operations.

2. A composite liner as claimed in claim 1, wherein the upper alloy steel layer is made of chrome-moly steel.

3. A composite liner as claimed in claim 1, wherein the upper steel laymer and lower rubber layer are further fastened by integral metal anchor.

4. A composite liner as claimed in claim 3, wherein said anchor is embedded within the rubber layer.

5. A composite line as claimed in claim 1 wherein the thickness of said upper metal layer is greater than the said lower rubber layer.

6. The composite mill liner as claimed in in claim 1, wherein the metal layer thickness in the plate area is at least around 40 mm, excluding the anchor area.

7. A composite miller liner as claimed in claim 6, wherein the rubber layer has a thickness of at least around 20 mm.

8. A composite mill liner as claimed in claim 1, wherein the said liner is capable of being retrofitted in a SAG/AG mill independent of the number of holes present in a row available in the inner wall of the shell of the mill.

9. A composite mill liner as claimed in claim 1, wherein, as the metal wears out, the liner becomes more resilient and its relative wear rate decreases.

10. A method of manufacturing composite mill liner comprising the steps of casting metal part according to the required lifter profile, heat treating and sand blasting the cast metal profile for surface cleaning, applying rubber adhesive compound to the bonded area to the metal part and aluminium clamp inserts, making the transfer mould assembly with the top part of the mould holding the metal profile and lower part of the mould holding the aluminium clamp inserts, symmetrically distributing the hot rubber blank in the lower mould part in the hydraulic press and heating, closing the prefabricated mould in the press and pressing to fix the metal layer to the lower rubber layer.

11. A method of manufacturing composite mill liner as claimed in claim 10 wherein the hydraulic press is of 1000 T capacity and heating process is carried out at 172 deg C. platen temperature.

12. A SAG/AG mill incorporating a composite liner as claimed in claim 1.
